(19) United States
(12) Patent Application Publication
(10) Pub. No.: US 2013/0194937 A1
(43) Pub. Date: Aug. 1, 2013

(54) METHOD AND APPARATUS FOR PROVIDING INTELLIGENT CODEC RATE ADAPTATION FOR WIRELESS USERS

(71) Applicants: Kamakshi Sridhar, Plano, TX (US); Jim Seymour, (US)

(72) Inventors: Kamakshi Sridhar, Plano, TX (US); Jim Seymour, (US)

(73) Assignee: Alcatel-Lucent USA Inc., Murray Hill, NJ (US)

(21) Appl. No.: 13/362,439

(22) Filed: Jan. 31, 2012

(51) Int. Cl. H04L 12/26

(52) U.S. Cl. 370/252

(57) ABSTRACT

The method includes receiving, at a network element, a media data packet sent from a first source user equipment (UE) towards a first destination UE; detecting, at the network element, congestion in at least one of a downlink channel between the network element and the first destination UE, and an uplink channel between the first source UE and the network element; identifying a second source UE that is transmitting first data to a second destination UE through the network element and has a subscriber priority level lower than the first source UE if the detecting detects congestion; sending a congestion indication that causes the second source UE to lower a rate at which the second source UE transmits the first data through the network element to the second destination UE if the detecting detects congestion; and sending the media data packet from the network element to the first destination UE.

### BACKGROUND OF THE INVENTION

1. Field

Example embodiments relate generally to handling codec rate adaptation for users of wireless communications networks, for example LTE networks.

2. Related Art

In LTE, codec rates for voice are assigned initially based on factors such as device characteristics. Voice codecs for LTE include, for example, adaptive multi rate—wideband (AMR-WB), AMR7.95, and AMR5.9. Likewise, different codes rates exist for video data. The codec rate for a given call, for video or voice data, can be adapted mid-call depending on explicit congestion notifications (ECN). The specification 3GPP 23.860 describes mechanisms by which the codec rate for a video or voice stream can be lowered based on ECNs, or increased based on a lack of ECNs midstream. Currently the adaptation of codec rates for video or voice users is based on congestion notifications received for that user.

### SUMMARY OF THE INVENTION

One or more embodiments relate to a method and apparatus for generating handling codec rate adaptation for users of a wireless communications network.

According to at least one example embodiment, a method of handling congestion in a wireless communications network may include receiving, at a network element, a media data packet sent from a first source user equipment (UE) towards a first destination UE; detecting, at the network element, congestion in at least one of a downlink channel between the network element and the first destination UE, and an uplink channel between the first source UE and the network element; identifying a second source UE that is transmitting first data to a second destination UE through the network element and has a subscriber priority level lower than the first source UE if the detecting detects congestion; sending a congestion indication that causes the second source UE to lower a rate at which the second source UE transmits the first data through the network element to the second destination UE if the detecting detects congestion; and sending the media data packet from the network element to the first destination UE.

According to at least one example embodiment, the identifying may include determining subscriber priority levels of a plurality of UE pairs, each of the plurality of UE pairs including two UEs communicating with one another via the network element, and choosing, as the second source UE, a UE from among a UE pair having a subscriber priority level lower than the first source UE.

According to at least one example embodiment, the identifying may further include determining which of the plurality of UE pairs has a lowest subscriber priority level, and choosing, as the second source UE, a UE from among the UE pair having the lowest priority level.

According to at least one example embodiment, the sending the congestion indication may include, at the network node, inserting the congestion indication into an alternate data packet and sending the alternate data packet from the network element to the second destination UE, the alternate data packet being one of a plurality of data packets included in the first data being sent from the second source UE to the second destination UE.

According to at least one example embodiment, the congestion indication may be an explicit congestion notification (ECN) code point.

According to at least one example embodiment, the network element may be an enhanced node B (eNB) and the wireless communications network follows an LTE protocol.

According to at least one example embodiment, the first destination UE may be associated with the eNB and the detecting may include detecting congestion in a downlink channel between the eNB and the first destination UE.

According to at least one example embodiment, the first source UE may be associated with the eNB and the detecting may include detecting congestion in an uplink channel between the first source UE and the eNB.

According to at least one example embodiment, the media data packet may be a voice data packet or a video data packet.

According to at least one example embodiment, a network apparatus for handling congestion in a wireless communications network may include a data receiving unit; a data transmitting unit; a memory unit configured to store parameters corresponding with user equipment (UEs) in communication with the network element; and a processing unit coupled to the data transmitting unit, the data receiving unit, and the memory unit. The processing unit may be configured to control operations including, receiving a media data packet sent from a first source user equipment (UE) towards a first destination UE; detecting congestion in at least one of a downlink channel between the network element and the first destination UE, and an uplink channel between the first source UE and the network element; identifying a second source UE that is transmitting first data to a second destination UE through the network element and has a subscriber priority level lower than the first source UE if the detecting detects congestion; sending a congestion indication configured to cause the second source UE to lower a rate at which the second source UE transmits the first data through the network element to the second destination UE if the detecting detects congestion; and sending the media data packet from the network element to the first destination UE.

### BRIEF DESCRIPTION OF THE DRAWINGS

Example embodiments will become more fully understood from the detailed description provided below and the accompanying drawings, wherein like elements are represented by like reference numerals, which are given by way of illustration only and thus are not limiting and wherein:

FIG. 1 illustrates a portion of a wireless communications network according to at least one example embodiment.

FIG. 2 is a data flow diagram illustrating a method providing codec rate adaptation using explicit congestion notifications (ECNs) according to at least one example embodiment.

FIG. 3A is a diagram illustrating an example structure of a network element according to at least one example embodiment.

FIG. 3B is a data flow diagram illustrating a method of providing codec rate adaptation using ECNs and subscriber priority levels according to at least one example embodiment.

FIG. 3C is a flow chart illustrating a method of providing codec rate adaptation using ECNs and subscriber priority levels from the perspective of a network element according to at least one example embodiment.

### DETAILED DESCRIPTION OF EXAMPLE EMBODIMENTS

Various at least one example embodiment will now be described more fully with reference to the accompanying drawings in which some example embodiments are shown.

Detailed illustrative embodiments are disclosed herein. However, specific structural and functional details disclosed herein are merely representative for purposes of describing at least one example embodiment. Example embodiments may, however, be embodied in many alternate forms and should not be construed as limited to only the embodiments set forth herein.

Accordingly, while example embodiments are capable of various adaptations and alternative forms, embodiments thereof are shown by way of example in the drawings and will herein be described in detail. It should be understood, however, that there is no intent to limit example embodiments to the particular forms disclosed, but on the contrary, example embodiments are to cover all adaptations, equivalents, and alternatives falling within the scope of example embodiments. Like numbers refer to like elements throughout the description of the figures. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

As used herein, the term user equipment (UE) may be considered synonymous to, and may hereafter be occasionally referred to, as a terminal, mobile unit, mobile station, mobile user, access terminal (AT), subscriber, user, remote station, access terminal, receiver, etc., and may describe a remote user of wireless resources in a wireless communication network. The term base station (BS) may be considered synonymous to and/or referred to as a base transceiver station (BTS), NodeB, extended Node B (eNB), access point (AP), etc. and may describe equipment that provides the radio baseband functions for data and/or voice connectivity between a network and one or more users.

Exemplary embodiments are discussed herein as being implemented in a suitable computing environment. Although not required, exemplary embodiments will be described in the general context of computer-executable instructions, such as program modules or functional processes, being executed by one or more computer processors or CPUs. Generally, program modules or functional processes include routines, programs, objects, components, data structures, etc. that performs particular tasks or implement particular abstract data types.

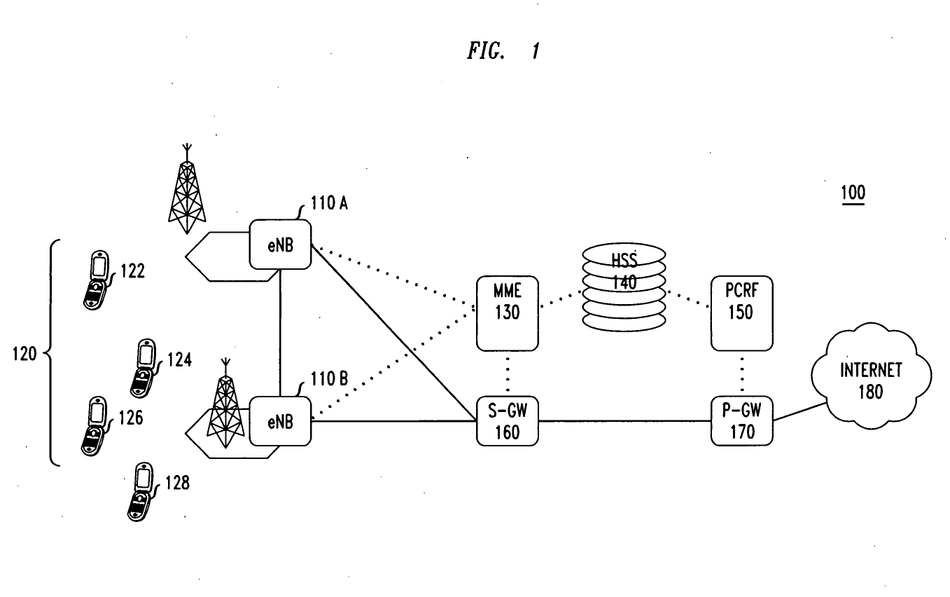

The program modules and functional processes discussed herein may be implemented using existing hardware in existing communication networks. For example, program modules and functional processes discussed herein may be implemented using existing hardware at existing network elements or control nodes (e.g., an AP shown in FIG. 1). Such existing hardware may include one or more digital signal processors (DSPs), application-specific-integrated-circuits, field programmable gate arrays (FPGAs) computers or the like.

In the following description, illustrative embodiments will be described with reference to acts and symbolic representations of operations (e.g., in the form of flowcharts) that are performed by one or more processors, unless indicated otherwise. As such, it will be understood that such acts and operations, which are at times referred to as being computer-executed, include the manipulation by the processor of electrical signals representing data in a structured form. This manipulation transforms the data or maintains it at locations in the memory system of the computer, which reconfigures or otherwise alters the operation of the computer in a manner well understood by those skilled in the art.

### Overview of Network Architecture

FIG. 1 illustrates a portion of a wireless communications network 100. Wireless communications network 100 may follow, for example, an LTE protocol. Wireless communications network 100 includes a mobility management entity (MME) 110, a first evolved node B (eNB) 110A, a second eNB 110B, a plurality of user equipments (UEs) 120 including first UE 122, second UE 124, third UE 126 and fourth UE 128, a home subscriber server (HSS) 140, a policy and charging rules function node (PCRF) 150, a serving gateway (S-GW) 160, and a public data network (PDN) gateway (P-GW) 170.

The UEs 120 may be in wireless communication with either of the first eNB 110A and the second eNB 110B. The first eNB 110A and the second eNB 110B are connected to the MME 130. Though not pictured, wireless communications network 100 may include other elements of an LTE core network in addition to MME 130. The UEs 120 may be, for example, mobile phones, smart phones, computers, or personal digital assistants (PDAs).

The first eNB 110A and the second eNB 110B may also be connected to the serving gateway 160. The S-GW 160 is capable of routing and forwarding user data packets of UEs connected to the first eNB 110A or the second eNB 110B. The S-GW 160 provides access for the first eNB 110A and the second eNB 110B to the P-GW 170. The P-GW 170 provides the first eNB 110A and the second eNB 110B with access to other packet data networks including, for example the internet 180, via the serving gateway 192. For the purpose of simplicity, the operations of the first eNB 110A and the second eNB 110B will be discussed primarily with reference to the first eNB 110A. However, the second eNB 110B is capable of operating in the same manner discussed with reference to the first eNB 110A.

### Explanation of Codec Rate Adaptation

UEs from among the plurality of UEs 120 may be sending voice data or video data to other UEs. UEs from among the plurality of UEs 120 sending voice data may choose a codec rate to use when sending the voice data. Higher codec rates correspond to higher fidelity voice data and a higher data rate while lower codec rates correspond to lower fidelity voice data and a lower data rate. Similarly, UEs from among the plurality of UEs 120 sending video data may choose a codec rate to use when sending the video data. The resources available within the first eNB 110A for delivering data to and from the UEs communicating with the first eNB 110A are limited. When the resources required to meet demands of the UEs communicating with the first eNB 110A meet or exceed the amount of resources available to the first eNB 110A, congestion results and data packets may be dropped by the first eNB 110A experiencing congestion. This may result in a reduced level of quality for UEs in communication with the eNB experiencing congestion.

In order to prevent and/or reduce congestion experienced in the wireless communications network 100, the wireless network 100 implements a codec rate adaptation scheme. For example, the first eNB 110A is capable of notifying UEs when congestion is being experienced, or is expected to be experienced in the near future. For example, the first eNB 110A may generate an indication of existing or approaching congestion using, for example, an explicit congestion notification (ECN). The ECN may be used to prompt a UE sending data via the eNB experiencing congestion to reduce the amount of data being sent by, for example, reducing a codec rate being used to send voice data, or reducing a maximum codec rate being used to send video data. The use of ECNs to prompt codec rate adaptation is discussed in the 3GPP 23.860 specification with respect to multimedia telephony services for IP multimedia subsystems (IMS) (MTSI) clients.

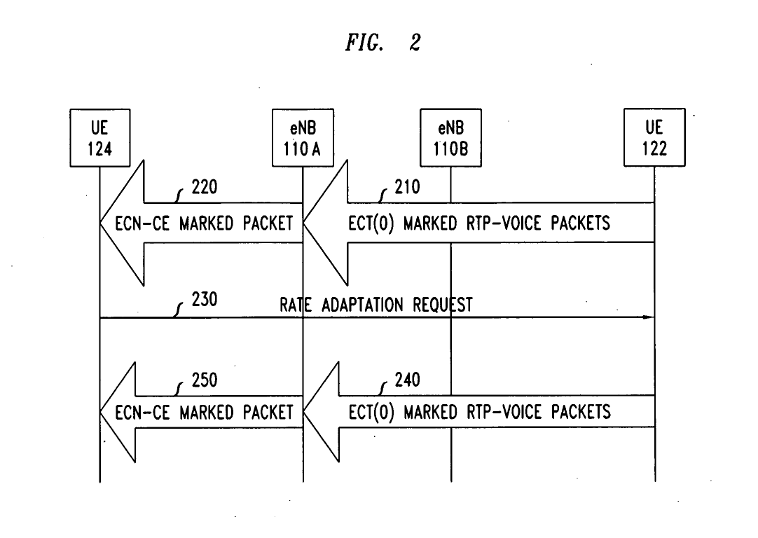

According to the 3GPP 23.860 specification, session description protocol (SDP) offer and answer procedures may be used to establish ECN usage between MTSI clients when ECN is enabled in the MTSI clients. After ECN usage has been negotiated, terminals designate voice or video media packets with the “ECT(0)” code point. If an eNB that supports ECN detects congestion on the downlink for a voice or video user, the eNB may designate ECT-marked downlink packets with the “ECN-CE” code point to indicate “congestion experienced”. The ECN-CE marked packet indicates to the MTSI client receiving the packet that it may be necessary to request new codec rates for the sender of the packet. The receiving MTSI client may determine which rate to request using, for example, known procedures described in the 3GPP specification TS 26.114. If the receiving MTSI client determines a rate request is necessary, the receiving MTSI client sends a rate request to the sending MTSI client requesting the sending MTSI client to use a lower transmission rate. For voice data, the rate request may request the use of a codec which has a lower code rate than a codec currently being used. For video data sent using an adaptive bit rate, the rate request may request the use of a lower maximum bit rate. A process for lowering congestion by using ECNs to effect codec rate adaptation will now be discussed below with reference to FIG. 2.

FIG. 2 is a data flow diagram illustrating a method providing codec rate adaptation using ECNs. The method illustrated in FIG. 2 is based on the 3GPP 23.860 specification.

FIG. 2 will be explained with reference to a scenario in which the first UE 122 and the second UE 124 are participating in a voice call, the second UE 124 is associated with the first eNB 110A, and the first eNB 110A detects congestion in the downlink to the second UE 124. The first UE 122, the second UE 124 and the first eNB 110A each support ECN. The first and second UEs 122 and 124 may be, for example, MTSI clients.

Referring to FIG. 2, the first UE 122 sends voice packets 210 marked with the code point ECT(0) towards the second UE 124. The voice packets are received by the eNB associated with the second UE 124, the first eNB 110A. Because the first eNB 110A detects congestion on the downlink channel to the second UE 124, the first eNB changes the code point of one or more of the voice packets to the ECN-CE code point, and sends the one or more ECN-CE marked packets 220 to the UE 124. After receiving the ECN-CE marked packets 220, the second UE 124 determines whether or not to request a codec rate change from the sender of the ECN-CE marked voice packet, the first UE 122. In the example illustrated in FIG. 2, the second UE 124 determines that a rate change is needed. Accordingly, the second UE 124 sends a rate adaptation request 230 to the first UE 122. In response, the first UE 122 lowers the codec rate used by the first UE 122 to send voice data packets to the second UE 124. The first UE 122 then sends, towards the second UE 124, voice packets 240 that are marked with the code point ECT(0) and have a reduced codec rate with respect to the previously sent voice packets 210. The first eNB 110A may determine that the downlink channel to the second UE 124 is still congested. Accordingly, the first eNB 110 may, again, change the code point of the voice packets to the ECN-CE code point, and send one or more ECN-CE marked packets 250 to the second UE 124.

Accordingly, in the method of using ECNs to handle network congestion illustrated in FIG. 2, once the first eNB 110A detects congestion in the downlink channel to the second UE 124, the first eNB 110A may generate an indication, the ECN-CE marked packet 220, which causes the second UE 124 to request a rate adaptation from the first UE 122.

Further, though FIG. 2 is discussed with respect to an example in which congestion is detected in the downlink channel between the second UE 124 and the first eNB 110A, ECNs may also be generated if congestion is detected in the uplink channel between the second UE 124 and the first eNB 110A. For example, if the first eNB 110A detects congestion in the uplink channel, the first eNB 110A may modify an uplink packet sent from the second UE 124 towards the first UE 122 via the first eNB 110A to include the ECN-CE code point. Upon receipt at the first UE 122, the ECN-CE marked packet would prompt the first UE 122 to send a rate adaptation request to the second UE 124. In response, the second UE 124 would lower the codec rate used by the second UE 124 to send voice data packets to the first UE 122.

In both cases of uplink congestion and downlink congestion a rate adaptation request is sent and the UE receiving the rate adaptation request responds to the rate adaptation request by using a lower, less data intensive, codec rate to send subsequent voice data to the other UE. Accordingly, in both cases, the experienced congestion may be reduced.

Additionally, though, for the purpose of simplicity, the method of FIG. 2 is discussed with reference only to a voice call in which voice packets are sent between the first UE 122 and the second UE 124, the method also applies to video data. For example, if the first UE 122 is sending video data to the second UE 124 via the first eNB 110A, and the first eNB 110A detects congestion in the downlink channel between the first eNB 110A and the second UE 124, the first eNB 110A may prompt the second UE 124 to send a rate adaptation request to the first UE 122 by modifying a video data packet sent from the first UE 122 towards the second UE 124 to include the ECN-CE code point. The first UE 122 may respond to the rate adaptation request by lowering a maximum bit rate used to encode the video data being sent to the second UE 124.

Likewise, if the second UE 124 is sending video data to the first UE 122 via the first eNB 110A, and the first eNB 110A detects congestion in the uplink channel between the first eNB 110A and the second UE 124, the first eNB 110A may prompt the first UE 122 to send a rate adaptation request to the second UE 124 by modifying a video data packet sent from the second UE 124 towards the first UE 122 to include the ECN-CE code point. The second UE 124 may respond to the rate adaptation request by lowering a maximum bit rate used to encode the video data being sent to the first UE 122.

### Method and Apparatus for Providing Codec Rate Adaptation Using ECNs and Subscriber Priority Levels

As is described above with reference to FIGS. 1 and 2, ECNs may be used to reduce codec rates of voice data senders. Accordingly, an amount of data being sent through, and thus an amount of congestion experienced by, the wireless communications network 100 may be reduced.

However, in the method illustrated above in FIG. 2, the process of reducing the codec rate of a given voice user does not consider information available on the first eNB 110A regarding other users, such as whether they are high priority voice users or guaranteed bit rate (GBR) video users (e.g., paying users), or lower priority voice or data users (e.g., non-paying users). For example, LTE networks provide for classification of subscribers into different subscriber priority levels. Examples of subscriber levels include gold, silver and bronze subscriber priority levels. The rank of a subscriber priority level may indicate, for example, a cost of the service paid for by a subscriber. Accordingly, subscribers with gold subscriber priority levels may be subscribers who pay a higher fee for a quality of experience (QoE) higher than subscribers having silver and bronze subscriber priority levels users. Likewise, subscribers with silver subscriber priority levels may be subscribers who pay a higher fee for a QoE higher than subscribers having bronze subscriber priority levels users.

Thus, when making decisions about allocating limited network resources of the communications network 100 to users of the wireless communications network 100 including, for example, decisions about lowering voice or video data codec rates for certain users, it may be desirable to take into account relative subscriber priority levels of the users. This way, when allocating the limited resources of the wireless network 100, a QoE of subscribers with higher subscriber priority levels can be maintained if possible.

As a result, current gold level users may be more likely to choose to continue paying the higher fees associated with the gold subscriber priority level. Further, bronze and silver level users may be more likely to choose to increase their fees by paying higher fees to become gold level subscribers.

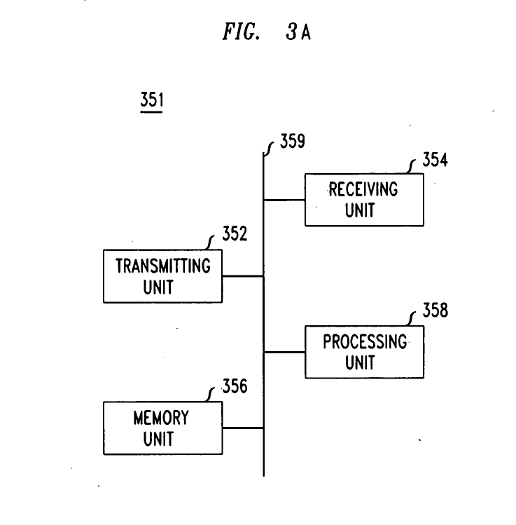

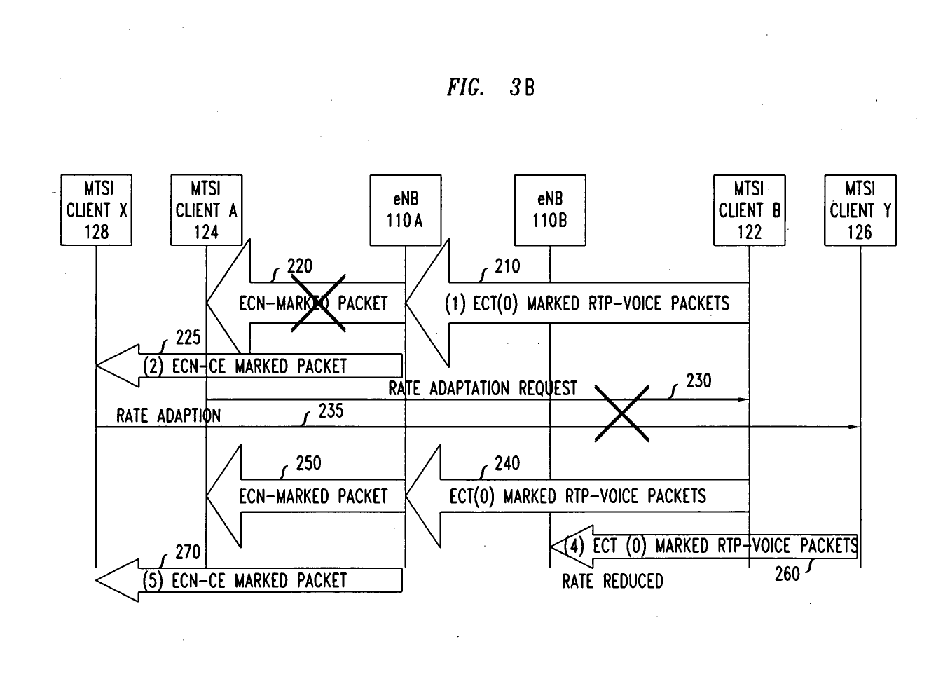

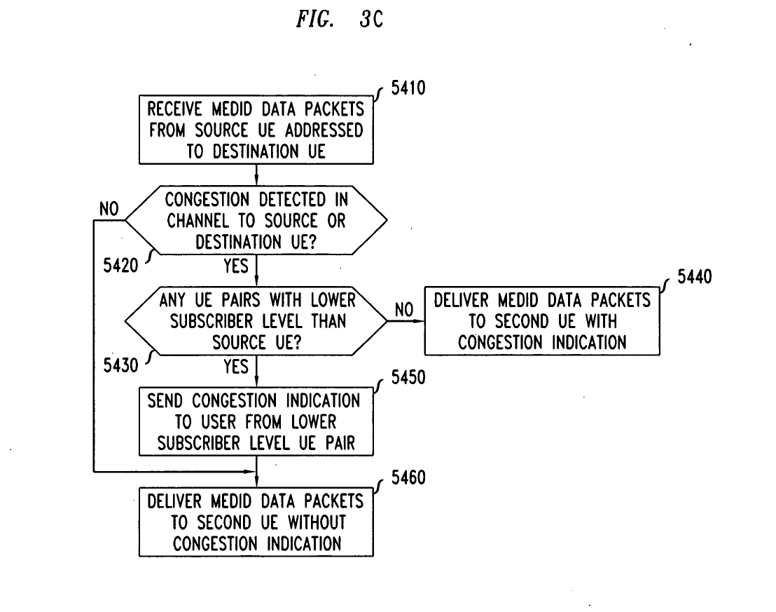

A method for lowering congestion by using ECNs to effect codec rate adaptation while taking into account users' subscriber priority levels will now be discussed below with reference to FIGS. 3A-3C.

FIG. 3A is a diagram illustrating an example structure of a network element 301. According to at least one example embodiment, either or both of the first eNB 110A and the second eNB 110B may have the structure and operation of the network element 301 described below. Referring to FIG. 3A, the network element 301 may include, for example, a data bus 359, a transmitting unit 352, a receiving unit 354, a memory unit 356, and a processing unit 358.

The transmitting unit 352, receiving unit 354, memory unit 356, and processing unit 358 may send data to and/or receive data from one another using the data bus 359. The transmitting unit 352 is a device that includes hardware and any necessary software for transmitting wired and/or wireless signals including, for example, data signals and control signals, via one or more wired and/or wireless connections to other network elements in the wireless communications network 100. For example, data and/or control signals may include voice data packets having the “ECT(0)” or “ECN-CE” code points.

The receiving unit 354 is a device that includes hardware and any necessary software for receiving wired and/or wireless signals including, for example, data signals and control signals, via one or more wired and/or wireless connections to other network elements in the wireless communications network 100.

The memory unit 356 may be any device capable of storing data including magnetic storage, flash storage, etc.

The processing unit 358 may be any device capable of processing data including, for example, a microprocessor configured to carry out specific operations based on input data, or capable of executing instructions included in computer readable code.

For example, the processing unit 358 is capable of determining subscriber priority levels of subscribers associated with each of the UEs, from among the UEs 120, in communication with the network element 301. Further, the processing unit is capable of comparing subscriber priority levels associated with two or more UEs to determine which UE is associated with the highest subscriber priority level.

Example methods for operating the network element 301, the first eNB 110A, and the second eNB 110B will now be discussed in greater detail below with reference to FIGS. 3B and 3C.

According to at least one example embodiment, each of the operations illustrated in, or described with respect to, FIGS. 3B and 3C as being performed by an eNB may be performed by, for example, one or more eNBs having the structure of the network element 301 as illustrated in FIG. 3A. For example, the memory unit 356 may store executable instructions corresponding to each of the operations described below with reference to in FIGS. 3B and 3C. Further, the processor unit 158 may be configured perform each of the operations described below with respect to FIGS. 3B and 3C. Further, according to at least one example embodiment, transmitted data and/or control signals may be transmitted through the transmitting unit 352, and received data and/or control signals may be received through the receiving unit 354.

FIG. 3B is a data flow diagram illustrating a method of providing codec rate adaptation using ECNs and subscriber priority levels according to at least one example embodiment.

Like FIG. 2, FIG. 3B will be explained with reference to a scenario in which the first UE 122 and the second UE 124 are participating in a voice call, the second UE 124 is associated with the first eNB 110A, and the first eNB 110A detects congestion in the downlink to the second UE 124. Further, the third UE 126 and the fourth UE 128 are also participating in a voice call, the fourth UE 128 is associated with the first eNB 110A, and the third and fourth UEs 126 and 128 are both associated with subscribers having lower subscriber priority levels than the first UE 122. The first UE 122, the second UE 124, the third UE 126, the fourth UE 128 and the first eNB 110A each support ECN. The first through fourth UEs 122˜128 may be, for example, MTSI clients.

Referring to FIG. 3B, the first UE 122 sends the voice packets 210 marked with the code point ECT(0) towards the second UE 124. The voice packets 210 are received by the eNB associated with the second UE 124, the first eNB 110A. As in FIG. 3B, the first eNB 110A detects congestion on the downlink channel to the second UE 124. However, instead of simply marking the voice packets of the first UE 124 with the ECN-CE code point, the first eNB 110A determines whether or not there is another UE that is better suited to experience a decreased codec rate than the first UE 122. For example, the first eNB 110A may obtain information regarding the subscriber priority level of each of the first through fourth UEs 122˜128 according to known methods. The first eNB 110A then uses the subscriber priority level information to determine that the third UE 126 and the fourth UE 128 are two UEs currently participating in a voice call via the first eNB 110A that have subscriber priority levels lower than that of the first UE 122. Then, instead of sending the ECN-CE marked packet 220 to the second UE 124, the first eNB 110 sends an ECN-CE marked packet 225 to the fourth UE 128. The first eNB 110 may send the voice packets 210 to the second UE 128 without including the ECN-CE code point.

After receiving the ECN-CE marked packets 225, the fourth UE 128 determines whether or not to request a codec rate change from the sender of the ECN-CE marked voice packet, the third UE 126, according to known methods. In the example illustrated in FIG. 3, the fourth UE 128 determines that a rate change is needed. Accordingly, the fourth UE 128 sends a rate adaptation request 235 to the third UE 126. In response, the third UE 126 lowers the codec rate it uses to send voice data packets to the fourth UE 128. The third UE 126 then sends, towards the second UE 124, voice packets 260 that are marked with the code point ECT(0) and have a reduced codec rate with respect to a previous codec rate of the third UE 126. Further, the first UE 122 may send additional voice packets 240 towards the second UE 124. The first eNB 110A may determine that the downlink channel to the second UE 124 is still congested. Accordingly, the first eNB 110A may, again, determine that the third and fourth UEs 126 and 128 have lower subscriber priority levels than the first UE 122, change the code point of voice packets being sent from the third UE 126 to the forth UE 128 to the ECN-CE code point, and send the ECN-CE marked packets 270 to the fourth UE 128.

Accordingly, in the method of using ECNs to handle network congestion illustrated in FIG. 3, once the first eNB 110A detects congestion in the downlink channel to the second UE 124, the first eNB 110A may generate an indication, the ECN-CE marked packet 225, which causes the fourth UE 128 to request a rate adaptation from the third UE 126. Because the third UE 126 responds to the rate adaptation request by using a lower, less data intensive, codec rate to send subsequent voice data to the fourth UE 128, the overall amount of data being handled in the wireless communications network 100 by the first eNB 110A may be reduced. Accordingly, overall congestion experienced by UEs in communication with the first eNB 110A may be reduced. Accordingly, a reduction in congestion may be achieved without requiring the UE associated with the higher subscriber priority level, the first UE 122, to assume a lower codec rate and generate voice packets having a lower level of fidelity, thus lowering the QoE for the first UE 122 and the second UE 124.

Further, though FIG. 3B is discussed with respect to an example in which congestion is detected in the downlink channel between the second UE 124 and the first eNB 110A, according to at least one example embodiment, ECNs may also be generated and sent to low level users if congestion is detected in the uplink channel between the second UE 124 and the first eNB 110A. For example, if the first eNB 110A detects congestion in the uplink channel, the first eNB 110A may determine that the third and fourth UEs 126 and 128 have lower subscriber priority levels than the first UE 122. The first eNB 110A may then modify an uplink packet sent from the fourth UE 128 towards the third UE 126 via the first eNB 110A to include the ECN-CE code point. Upon receipt at the third UE 126, the ECN-CE marked packet would prompt the third UE 126 to send a rate adaptation request to the fourth UE 128. In response, the fourth UE 128 would lower the codec rate used by the fourth UE 128 to send voice data packets to the third UE 126.

FIG. 3C is a flow chart illustrating a method of providing codec rate adaptation using ECNs and subscriber priority levels from the perspective of a network element. FIG. 3C will be explained with reference to both a downlink case where the first eNB 110A handles potential congestion in a downlink channel between the first eNB 110A and the second UE 124, and an uplink case where the first eNB 110A handles potential congestion in an uplink channel between the second UE 124 and the first eNB 110A. Though, for the purpose of simplicity, FIG. 3C is described below with reference only to the first eNB 110A, the operations described below may also be performed by the second eNB 110B.

Referring to FIG. 3C, in step S410, one or more media data packets addressed to a destination UE are received from a source UE. For example, in a downlink case, the first UE 122 may be the source UE and the first eNB 110A may receive, from the first UE 122, one or more media data packets addressed to the second UE 124. In an uplink case, the second UE 124 may be the source UE and the first eNB 110A may receive, from the second UE 124, one or more media data packets addressed to the first UE 122. The one or more media data packet may be, for example, voice data packets or video data packets. The one or more media data packets may include ECT(0) code points indicating that the source UE is ECN capable.

In step S420, a congestion determination is made by the eNB. For example, in the downlink case, a determination may be made regarding whether or not congestion exists on the downlink channel between the first eNB 110A and the second UE 124. In the uplink case, a determination may be made regarding whether or not congestion exists on the uplink channel between the second UE 124 and the first eNB 110A. The first eNB 110A may determine whether or not congestion exists on the downlink channel or the uplink channel with the first UE 124 according to known methods.

If congestion is not determined to exist in step S420, the first eNB 110A may proceed to step S460.

In step S460, the voice packets received from the source UE are delivered to the destination UE without adding a congestion indication, and the process may end. For example, in the downlink case, the first eNB 110A may forward the media data packets received from the first UE 122 in step S410 to the second UE 124 without changing a code point of the received media data packets from the ECT(0) code point to the ECN-CE code point. In the uplink case, the first eNB 110A may forward the media data packets received from the second UE 124 in step S410 to the first UE 122 without changing a code point of the received voice packets from the ECT(0) code point to the ECN-CE code point.

Returning to step S420, if the first eNB 110A determines that congestion does exist on the downlink channel to the second UE 124 in the downlink case, or congestion exists in the uplink channel from the second UE 124 in the uplink case, the first eNB 110A may proceed to step S430.

In step S430, a determination is made regarding whether or not any UE pairs exist having subscriber priority levels lower than the subscriber priority level of the source UE. For example, in the downlink case, the first eNB 110A may determine whether or not there are any UE pairs communicating via the first eNB 110A which have subscriber priority levels lower than that of the first UE 122. For example, the eNB 110A may determine the subscriber priority levels (e.g., gold, silver or bronze) of each UE participating in a voice communication with another UE via the first eNB 110A. The first eNB may consider each set of two UEs communicating with one another via the first eNB 110A to be a UE pair. The first eNB 110 may then compare the subscriber priority level of the first UE 122 to the subscriber priority levels of the identified UE pairs to determine if any UE pairs exist having lower subscriber priority levels than the first UE 122.

Likewise, in the uplink case, the first eNB 110 may compare the subscriber priority level of the second UE 124 to the subscriber priority levels of the identified UE pairs to determine if any UE pairs exist having lower subscriber priority levels than the second UE 124.

For example, the first eNB 110A may consider a highest subscriber priority level associated with either of the UEs in each UE pair to be the subscriber priority level for the UE pair. For example, if a UE pair includes a UE associated with a gold subscriber priority level communicating with a UE associated with a silver subscriber priority level, the eNB 110A may consider the subscriber priority level of the UE pair to be gold. The first eNB 110A may obtain subscriber priority level information for one or more UEs in communication with the eNB 110A according to know methods.

If, in step S430, no UE pairs with subscriber priority levels lower than that of the source UE are identified, the first eNB 110A proceeds to step S440.

In step S440 the media data packets received in step S410 from the source UE are delivered to the destination UE with a congestion indication.

The congestion indication sent by the first eNB 110A in step S440 may be anything which is capable of indicating the existence of congestion in the wireless network communication network 100. For example, in the downlink case, the first eNB 110A may change the code point of the media data packets received from the first UE 122 from the ECT(0) code point to the ECN-CE code point thus indicating the presence of congestion in the downlink channel between the first eNB 110A and the second UE 124. In the uplink case, the first eNB 110A may change the code point of the media data packets received from the second UE 124 from the ECT(0) code point to the ECN-CE code point thus indicating the presence of congestion in the uplink channel between the second UE 124 and the first eNB 110A.

The destination UE may respond to the ECN-CE marked voice packet by sending a codec rate adaptation request to the source UE. The source UE may respond to the rate adaptation request by lowering a codec rate used to send subsequent voice packets to the destination UE, thus reducing the amount of network resources needed to deliver subsequent voice packets from the source UE to the destination UE.

Returning to step S430, if one or more UE pairs are identified which has a subscriber priority level lower than that of the source UE, the first eNB 110A proceeds to step S450.

In step S450, a congestion indication is sent to at least one of the one or more UE pairs identified in step S430 as having a subscriber priority level lower than that of the source UE.

For example, in the downlink case, the third UE 126 may be sending media data packets to the fourth UE 128 via the first eNB 110A. Further, in step S430, the first eNB 110A may identify a UE pair including the third UE 126 and the fourth UE 128 as a UE pair having a lower subscriber priority level than the source UE, first UE 122. Accordingly, in step S450, the first eNB 110A may send a congestion indication to the fourth UE 128.

The congestion indication sent by the first eNB 110A in step S450 may be anything which is capable of indicating the existence of congestion in the wireless network communication network 100. For example, the first eNB 110A may change the code point of a media data packet received from the third UE 126 from the ECT(0) code point to the ECN-CE code point. As is illustrated above in FIG. 3B, the fourth UE 128 may respond to the ECN-CE marked media data packet by sending a codec rate adaptation request to the third UE 126. The third UE 126 may respond to the rate adaptation request by lowering a codec rate used to send subsequent voice packets to the fourth UE 128, thus reducing the amount of network resources needed to deliver subsequent voice packets from the third UE 126 to the fourth UE 128, and the amount of network resources being used by the first eNB 110A. Accordingly, a reduction in network congestion may be achieved without reducing a QoE of the first UE 122.

In the uplink case, the fourth UE 128 may be sending media data packets to the third UE 126 via the first eNB 110A. Further, in step S430, the first eNB 110A may identify a UE pair including the third UE 126 and the fourth UE 128 as a UE pair having a lower subscriber priority level than the source UE, first UE 122. Accordingly, in step S450, the first eNB 110A may send a congestion indication to the third UE 126 by, for example, adding an ECN-CE code point to a media data packet sent from the fourth UE 128 to the third UE 126. The third UE 126 may respond to the ECN-CE marked media data packet by sending a codec rate adaptation request to the fourth UE 128. The fourth UE 128 may respond to the rate adaptation request by lowering a codec rate used to send subsequent voice packets to the third UE 126.

According to at least one example embodiment, if in step S430, the first eNB 110A identifies multiple UE pairs having a lower priority level than the source UE, then in step S450, the first eNB 110A may choose, as the UE pair to which to send the congestion notification, the UE pair having the lowest subscriber priority level from among all the identified UE pairs.

After step S450, the first eNB 110A may proceed to step S460 and deliver the media data packets received from the source UE in step S410 to the destination UE without adding a congestion indication.

Accordingly, using the method of providing codec rate adaptation using ECNs and subscriber priority levels discussed above with reference to FIG. 3C, congestion detected by an eNB in either an uplink channel or a downlink channel for transmitting media data packets may be mitigated while removing or reducing the need to lower a voice and/or video codec rate for high priority subscribers.

Example embodiments being thus described, it will be obvious that the same may be varied in many ways. Such variations are not to be regarded as a departure from example embodiments, and all such modifications are intended to be included within the scope of example embodiments.

What is claimed:

1. A method of handling congestion in a wireless communications network, the method comprising:
receiving, at a network element, a media data packet sent from a first source user equipment (UE) towards a first destination UE;
detecting, at the network element, congestion in at least one of a downlink channel between the network element and the first destination UE, and an uplink channel between the first source UE and the network element;
identifying a second source UE that is transmitting first data to a second destination UE through the network element and has a subscriber priority level lower than the first source UE if the detecting detects congestion;
sending a congestion indication that causes the second source UE to lower a rate at which the second source UE transmits the first data through the network element to the second destination UE if the detecting detects congestion; and
sending the media data packet from the network element to the first destination UE.

2. The method of claim 1, wherein the identifying includes determining subscriber priority levels of a plurality of UE pairs, each of the plurality of UE pairs including two UEs communicating with one another via the network element, and choosing, as the second source UE, a UE from among a UE pair having a subscriber priority level lower than the first source UE.

3. The method of claim 2, wherein the identifying further includes,
determining which of the plurality of UE pairs has a lowest subscriber priority level, and
choosing, as the second source UE, a UE from among the UE pair having the lowest priority level.

4. The method of claim 1, wherein the sending the congestion indication includes, at the network node, inserting the congestion indication into an alternate data packet and sending the alternate data packet from the network element to the second destination UE, the alternate data packet being one of a plurality of data packets included in the first data being sent from the second source UE to the second destination UE.

5. The method of claim 4, wherein the congestion indication is an explicit congestion notification (ECN) code point.

6. The method of claim 1, wherein the network element is an enhanced node B (eNB) and the wireless communications network follows an LTE protocol.

7. The method of claim 6, wherein the first destination UE is associated with the eNB and the detecting includes detecting congestion in a downlink channel between the eNB and the first destination UE.

8. The method of claim 6, wherein the first source UE is associated with the eNB and the detecting includes detecting congestion in an uplink channel between the first source UE and the eNB.

9. The method of claim 1, wherein the media data packet is a voice data packet or a video data packet.

10. A network apparatus for handling congestion in a wireless communications network, the apparatus comprising:
a data receiving unit;
a data transmitting unit;
a memory unit configured to store parameters corresponding with user equipment (UEs) in communication with the network element; and
a processing unit coupled to the data transmitting unit, the data receiving unit, and the memory unit and configured to control operations including,
receiving a media data packet sent from a first source user equipment (UE) towards a first destination UE;
detecting congestion in at least one of a downlink channel between the network element and the first destination UE, and an uplink channel between the first source UE and the network element;
identifying a second source UE that is transmitting first data to a second destination UE through the network element and has a subscriber priority level lower than the first source UE if the detecting detects congestion;
sending a congestion indication configured to cause the second source UE to lower a rate at which the second source UE transmits the first data through the network element to the second destination UE if the detecting detects congestion; and
sending the media data packet from the network element to the first destination UE.

11. The network apparatus of claim 10, wherein the processor is configured to control the identifying such that the identifying includes determining subscriber priority levels of a plurality of UE pairs, each of the plurality of UE pairs including two UEs communicating with one another via the network element, and choosing, as the second source UE, a UE from among a UE pair having a subscriber priority level lower than the first source UE.

12. The network apparatus of claim 11, wherein the processor is further configured to control the identifying such that the identifying further includes,
determining which of the plurality of UE pairs has a lowest subscriber priority level, and
choosing, as the second source UE, a UE from among the UE pair having the lowest priority level.

13. The network apparatus of claim 10, wherein the processor is configured to control the sending the congestion indication such that the sending the congestion indication includes inserting the congestion indication into an alternate data packet and sending the alternate data packet from the network element to the second destination UE, the alternate data packet being one of a plurality of data packets included in the first data being sent from the second source UE to the second destination UE.

14. The network apparatus of claim 13, wherein the congestion indication is an explicit congestion notification (ECN) code point.

15. The network apparatus of claim 10, wherein the network element is an enhanced node B (eNB) and the wireless communications network follows an LTE protocol.

16. The network apparatus of claim 15, wherein the first destination UE is associated with the eNB and the processor is configured to control the detecting such that the detecting includes detecting congestion in a downlink channel between the eNB and the first destination UE.

17. The network apparatus of claim 15, wherein the first source UE is associated with the eNB and the processor is configured to control the detecting such that the detecting includes detecting congestion in an uplink channel between the first source UE and the eNB.

18. The network apparatus of claim 10, wherein the media data packet is a voice data packet or a video data packet.
